(19) United States
(12) Patent Application Publication
(10) Pub. No.: US 2013/0134133 A1
(43) Pub. Date: May 30, 2013

(54) DEVICES AND METHODS FOR SEVERING FASTENER HEADS

(71) Applicants: Mervyn Rudgley, Mission Viejo, CA (US); Kenneth Gold, Bell Canyon, CA (US); Michael Gibbons, Seal Beach, CA (US)

(72) Inventors: Mervyn Rudgley, Mission Viejo, CA (US); Kenneth Gold, Bell Canyon, CA (US); Michael Gibbons, Seal Beach, CA (US)

(21) Appl. No.: 13/637,199

(22) PCT Filed: Mar. 25, 2011
(86) PCT No.: PCT/US11/29996

§ 371 Date: Dec. 12, 2012

(30) Foreign Application Priority Data
Mar. 26, 2010 (US) 61318192

(51) Int. Cl. B23H 1/00

(52) U.S. Cl. CPC B23H 1/00
USPC 219/69.15

(57) ABSTRACT

Devices and methods for removal of fasteners by Electro-discharge Machining (EDM) such that portions of the fastener, such as a flange head, may be separated from other portions of the fastener, such as a shank.

### RELATED APPLICATIONS

This application claims the full Paris Convention benefit of and priority to U.S. Provisional Patent Application Ser. No. 61/318,192, filed Mar. 26, 2010, the contents of which are incorporated by reference herein in its entirety, as if fully set forth herein. This application incorporates by reference U.S. application Ser. No. 12/603,507, filed Oct. 21, 2009, as if fully set forth herein.

### BACKGROUND

### Field

This disclosure relates to electrical discharge machining (EDM).

### SUMMARY

According to some exemplary implementations, disclosed is an EDM device, comprising: an erosion electrode having an outer diameter exceeding the outer diameter of a shank of a fastener, wherein the erosion electrode is configured to be advanced longitudinally through a head of a fastener and to a frame coating on a frame base.

The erosion electrode may have an inner diameter that is less than the diameter of the shank of the fastener. The erosion electrode is a hollow cylinder. The erosion electrode may be a solid cylinder. The erosion electrode may be a plurality of pins. The erosion electrode may be configured to be rotated as it is advanced longitudinally. The erosion electrode may be configured to be rotated about an axis of rotation corresponding to a central axis of the fastener. A power supply may be configured to provide a voltage difference between the erosion electrode and at least one of the fastener and the frame coating. A ground electrode may be configured to contact at least one of the fastener and the frame coating.

According to some exemplary implementations, disclosed is a method, comprising: providing an erosion electrode to a fastener in a frame base, the frame base having a frame coating on a surface thereof and the fastener having a head extending beyond the frame coating and a shank within the frame base; eroding an eroded space, the eroded space having an outer diameter exceeding the outer diameter of the shank and extending through the head of the fastener and to the frame coating.

Eroding an eroded space may comprise: providing a voltage difference between the erosion electrode and at least one of the fastener and the frame coating. Eroding an eroded space may comprise: advancing the erosion electrode longitudinally along the axis of the fastener. Eroding an eroded space may comprise: rotating the erosion electrode as it is advanced longitudinally. The eroded space may extend through a portion of the frame coating. The erosion electrode may be a hollow cylinder. The erosion electrode may be a solid cylinder. The erosion electrode may be a plurality of pins. A flange of the head may be separated from a remainder of the fastener. The frame base may remain intact. Advancing the erosion electrode longitudinally along the axis of the fastener may comprise: sensing and recording a contact location when the erosion electrode is in contact with an outer surface of the fastener; tracking a longitudinal distance traveled relative to the contact position; stopping advancement of the erosion electrode when the longitudinal distance traveled is equal to the distance between the contact position and at least one location within the frame coating.

### DRAWINGS

The above-mentioned features of the present disclosure will become more apparent with reference to the following description taken in conjunction with the accompanying drawings wherein like reference numerals denote like elements and in which:

FIG. 1 shows a sectional view of an erosion electrode approaching a fastener;

FIG. 2 shows a sectional view of an erosion electrode penetrating a fastener and a portion of a frame coating;

FIG. 3 shows a sectional view of an eroded space in a fastener and a frame coating;

FIG. 4 shows a sectional view of a head of a fastener removed from the shank of the fastener;

FIG. 5 shows a sectional view of an erosion electrode approaching a fastener;

FIG. 6 shows a sectional view of an erosion electrode penetrating a fastener and a portion of a frame coating;

FIG. 7 shows a sectional view of an eroded space in a fastener and a frame coating;

FIG. 8 shows a sectional view of a head of a fastener removed from the shank of the fastener;

FIG. 9 shows a sectional view of an erosion electrode approaching a fastener;

FIG. 10 shows a sectional view of an erosion electrode penetrating a fastener and a portion of a frame coating;

FIG. 11 shows a sectional view of an eroded space in a fastener and a frame coating;

FIG. 12 shows a sectional view of a head of a fastener removed from the shank of the fastener;

FIG. 13 shows a sectional view of an erosion electrode approaching a fastener;

FIG. 14 shows a sectional view of an erosion electrode penetrating a fastener;

FIG. 15 shows a sectional view of an erosion electrode penetrating a fastener and a portion of a frame coating;

FIG. 16 shows a sectional view of an erosion electrode approaching a fastener;

FIG. 17 shows a sectional view of an erosion electrode penetrating a fastener and a portion of a frame coating;

FIG. 18 shows a sectional view of an eroded space in a fastener and a frame coating; and

FIG. 19 shows a sectional view of a head of a fastener removed from the shank of the fastener.

### DETAILED DESCRIPTION

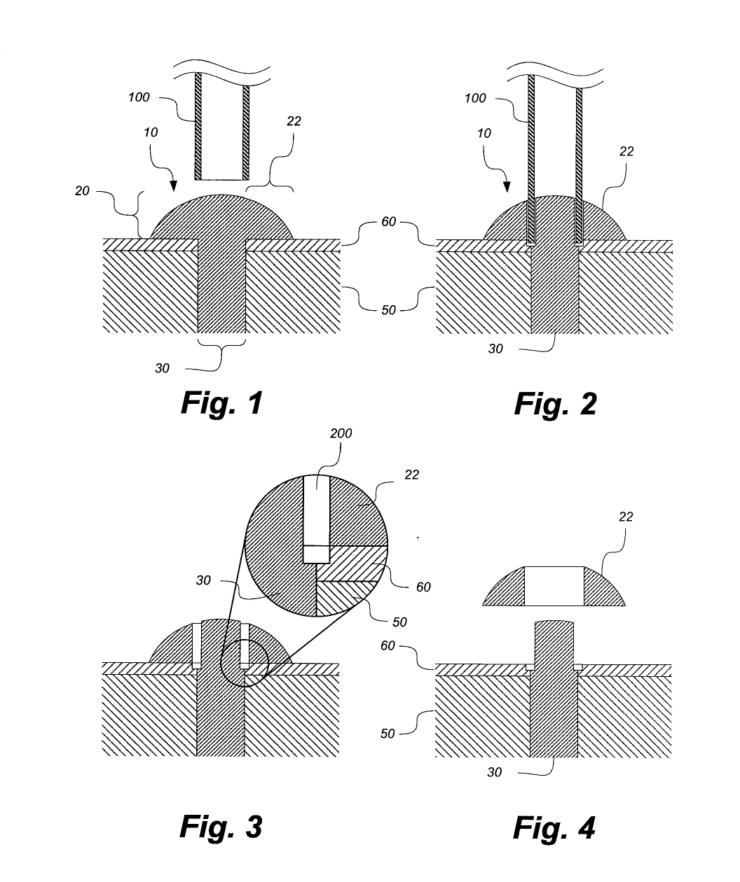

According to some exemplary implementations, disclosed is an EDM device for separating head 22 of fastener 10 from shank 30 of fastener 10. As shown in the FIGS. 1-19, fastener 10 may include shank 30 extending through at least a portion of frame base 50 and frame coating 60. Shank 30 may have a known or determinable shape and geometry. For example, shank 30 may be generally cylindrical with a known outer diameter. As shown in the Figures, fastener 10 may include head 20 protruding from at least a portion of at least one of frame base 50 and frame coating 60. Head 20 may include flange 22, corresponding to the portion of head 20 that extends radially beyond the outer diameter of shank 30.

According to some exemplary implementations, fastener 10 may interface with at least a portion of at least one of frame base 50 and frame coating 60. For example, fastener 10 may be fitted within or threaded onto at least one of frame base 50 and frame coating 60. Fastener 10 may interface with a collar (not shown) at a side of frame base 50 and frame coating 60 opposite head 20 of fastener 10. According to some exemplary implementations, it may be advantageous to facilitate removal of fastener 10 without separation thereof from a collar or other structure fixed thereto. For example, it may be advantageous to remove fastener 10 in a direction opposite the side containing head 20.

As shown in the figures, erosion electrode 100 of an EDM device may be of a variety of shape, sizes, and configurations. According to some exemplary implementations, erosion electrode 100 may be configured to remove head 20, flange 22, or at least portions thereof from shank 30. For example, as shown in FIGS. 1 and 2, erosion electrode 100 may be a hollow cylinder. As shown in FIG. 2, erosion electrode 100 may be advanced longitudinally along an axis. The axis may be coaxial with, parallel to, or otherwise aligned with a central axis of fastener 10. Erosion electrode 100 may have an outer diameter equal to or exceeding the outer diameter of shank 30 of fastener 10. As used herein, outer diameter of erosion electrode 100 may correspond to the radially outermost limit or distance from a central axis of erosion electrode 100, at one or more points during a process.

According to some exemplary implementations, as shown in FIG. 2, erosion electrode 100 is configured to be advanced longitudinally through head 20 of fastener 10 and to frame coating 60 on frame base 50. According to some exemplary implementations, frame coating 60 may be distinct from frame base 50. For example, frame coating 60 may be a different material from frame base 50, or frame coating 60 may be a separate portion of the same material as frame base 50. Frame coating 60 may be separable from or integral with frame base 50. According to some exemplary implementations, erosion of frame coating 60 may be acceptable, whereas erosion of frame base 50 may be undesirable.

According to some exemplary implementations, as shown in FIG. 2, erosion electrode 100 may be advanced to penetrate at least a portion of frame coating 60. Erosion electrode 100 may be configured to erode eroded space 200 by an EDM process. For example, a voltage difference may be provided from a power supply between erosion electrode 100 and at least one of fastener 10, frame coating 60, frame base 50, and any component in electric conductivity with one or more of the above. A dielectric fluid may be provided between erosion electrode 100 and one of the above. At a given voltage, the dielectric fluid may experience breakdown, and a plasma event may occur, causing at least a portion of fastener 10 or frame coating 60 to become eroded, leaving eroded space 200 at the location of the plasma event. A series of plasma events may cumulatively develop eroded space 200.

According to some exemplary implementations, as shown in FIG. 3, eroded space 200 may extend at least entirely through head 20 of fastener, separating flange 22 from shank 30. For example, eroded space 200 may extend to or into at least a portion of frame coating 60. Where desired, eroded space 200 may not extend into frame base 50.

According to some exemplary implementations, methods and configurations may be provided to verify the location of erosion electrode 100 and extent of eroded space 200. For example, a reference point (such as a contact location) may be sensed and recording as erosion electrode 100 is in contact with an outer surface of fastener 10. The distance from the reference point may be tracked as a longitudinal distance travelled there from. The distance from the reference point to a transition from fastener 10 to frame coating 60 or from frame coating 60 to frame base 50 may be known or determinable, such that the distance traveled may be determined relative to at least one of the transition from fastener 10 to frame coating 60 or from frame coating 60 to frame base 50. Advancement of erosion electrode 100 may be stopped when the longitudinal distance travelled corresponds to the distance between the reference point and at least one location above or within frame coating 60. Other methods and mechanisms for tracking advancement of at least erosion electrode 100 may be employed, as shall be appreciated by those having ordinary skill in the relevant art, and as contemplated by the present disclosure.

According to some exemplary implementations, erosion electrode 100 may be rotated about an axis while being advanced longitudinally.

According to some exemplary implementations, as shown in FIG. 4, at least flange 22 may be removed from shank 30. Where eroded space 200 extends at least to frame coating 60, flange 22 may have already been physically severed from shank 30. In such a case, removal of flange 22 requires no additional force or violence of fastener 10. Upon removal of flange 22, shank 30 may be removed in an opposite direction.

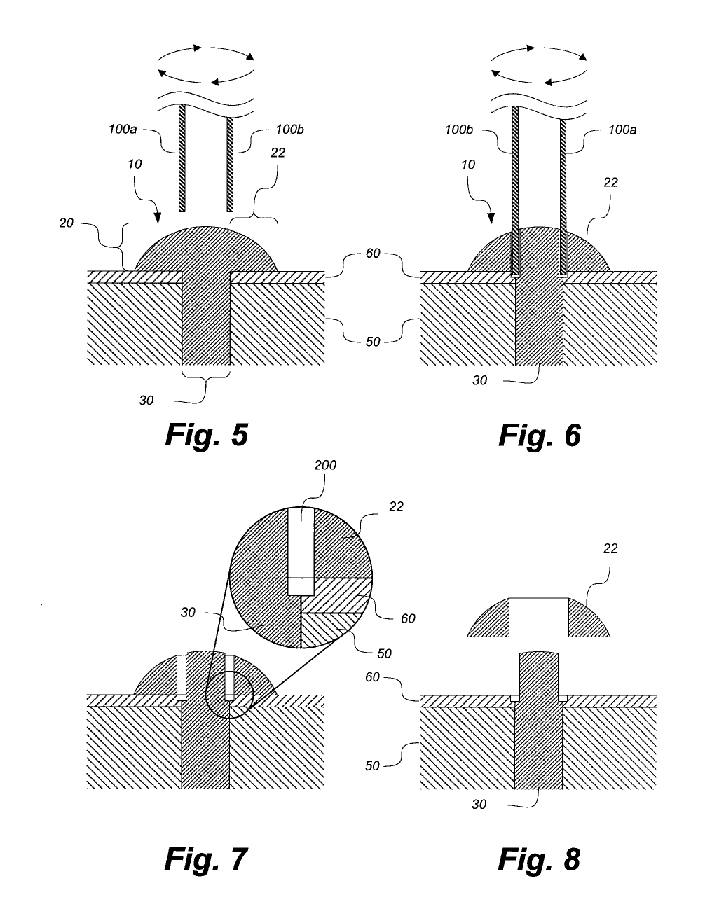

According to some exemplary implementations, erosion electrode 100 may include one or more point electrodes. As shown in FIGS. 5 and 6, a plurality of point electrodes 100a and 100b may be provided and rotated about an axis while advancing longitudinally. Erosion electrodes 100a and 100b may cumulatively provide an outer diameter defined by the rotation about an axis. As shown in FIG. 7, the rotation and advancement or point electrodes 100a and 100b may result in an eroded space 200 similar to that caused by erosion electrode 100 as a hollow cylinder, as shown in FIG. 3. Accordingly, as shown in FIG. 8, flange 22 may be removed in a manner as shown in FIG. 4.

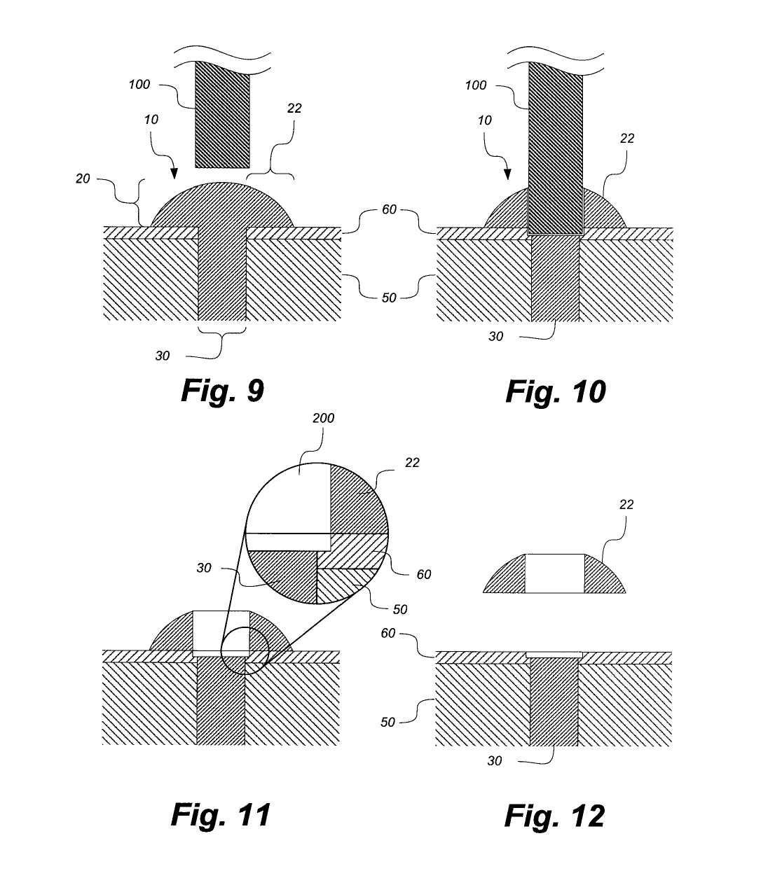

According to some exemplary implementations, erosion electrode 100 may be a solid cylinder, as shown in FIGS. 9 and 10. As shown in FIG. 11, erosion electrode 100 may define an uninterrupted eroded space 200. Accordingly, flange 22 may be removed, as shown in FIG. 12.

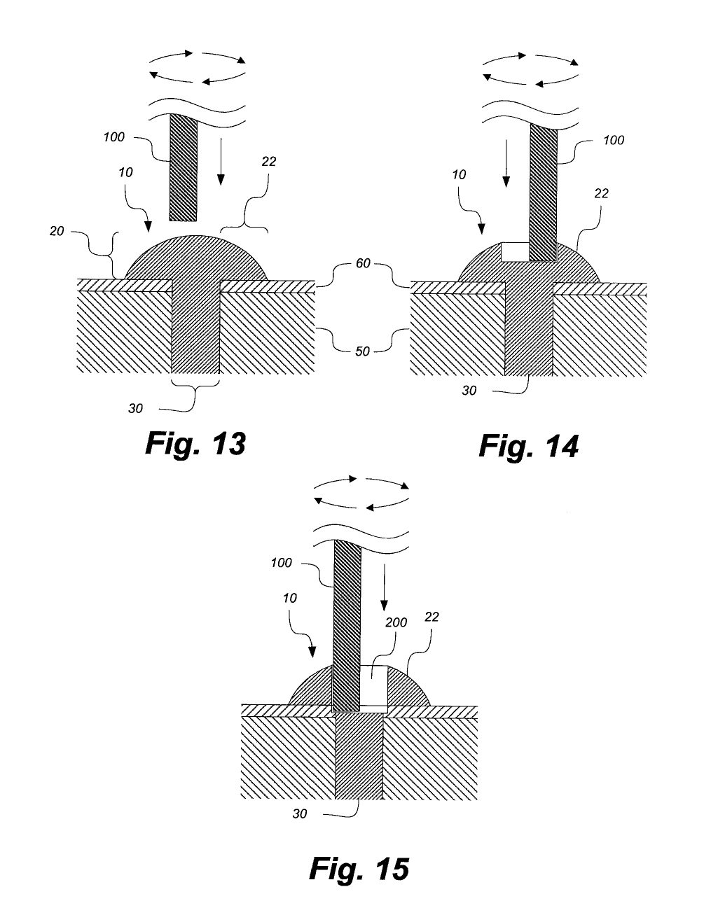

According to some exemplary implementations, erosion electrode 100 may rotate at least about an axis other than its own central axis. For example, as shown in FIGS. 13, 14, and 15, erosion electrode 100 may have a central axis parallel to, but not coaxial with, the central axis of fastener 10. Erosion electrode 100 may also be rotated about its own central axis. Such rotation(s) may be performed contemporaneously with longitudinal advancement of erosion electrode 100. According to some exemplary implementations, eroded space 200 resulting from such operations may be similar to those shown in FIGS. 3 and 4 where erosion electrode 100 is sufficiently narrow, or similar to that shown in FIGS. 11 and 12, where erosion electrode 100 is sufficiently wide. Accordingly, removal of flange 22 may be facilitated thereby.

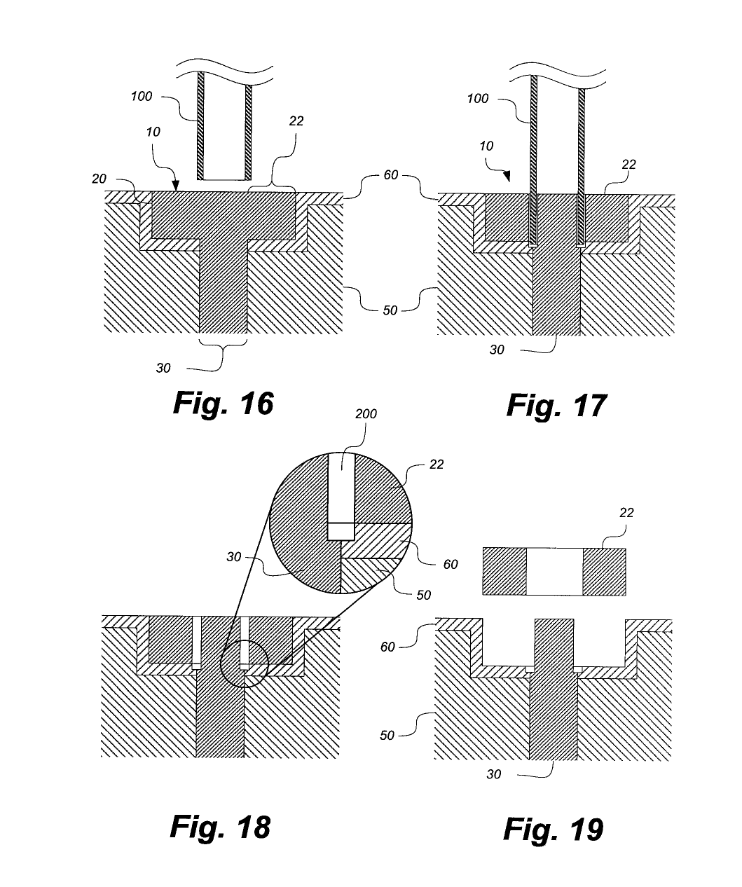

According to some exemplary implementations, removal of a flathead (non-protruding) fastener may be performed. As shown in FIGS. 16, 17, 18, and 19, at least one of frame base 50 and frame coating 60 may include a countersink portion. Head 20 may extend only beyond some portions of at least one of frame base 50 and frame coating 60. Head 20 may be configured to be substantially level with other portions of at least one of frame base 50 and frame coating 60. Accordingly, devices and methods disclosed herein may be applied to such fastener 10, as shown in FIGS. 17, 18, and 19.

While the method and apparatus have been described in terms of what are presently considered to be the most practical and preferred implementations, it is to be understood that the disclosure need not be limited to the disclosed implementations. It is intended to cover various modifications and similar arrangements included within the spirit and scope of the claims, the scope of which should be accorded the broadest interpretation so as to encompass all such modifications and similar structures. The present disclosure includes any and all implementations of the following claims.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects of the disclosure both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the disclosure, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these disclosure(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular implementation, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative implementations.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. An EDM device, comprising:
an erosion electrode having an outer diameter exceeding the outer diameter of a shank of a fastener, wherein the erosion electrode is configured to be advanced longitudinally through a head of a fastener and to a coating on a base.

2. The EDM device of claim 1, wherein the erosion electrode has an inner diameter that is less than the diameter of the shank of the fastener.

3. The EDM device of claim 1, wherein the erosion electrode is a hollow cylinder.

4. The EDM device of claim 1, wherein the erosion electrode is a solid cylinder.

5. The EDM device of claim 1, wherein the erosion electrode is a plurality of pins.

6. The EDM device of claim 1, wherein the erosion electrode is configured to be rotated as it is advanced longitudinally.

7. The EDM device of claim 1, wherein the erosion electrode is configured to be rotated about an axis of rotation corresponding to a central axis of the fastener.

8. The EDM device of claim 1, further comprising, a power supply configured to provide a voltage difference between the erosion electrode and at least one of the fastener and the coating.

9. The EDM device of claim 1, further comprising, a ground electrode configured to contact at least one of the fastener and the coating.

10. The EDM device of claim 9, further comprising a dielectric fluid at the electrode and in contact with the fastener and coating.

11. A method of severing a head from a fastener, the method comprising:
providing an erosion electrode to a fastener in a frame base, the frame base having a frame coating on a surface thereof and the fastener having a head with an outer diameter extending beyond the frame coating and a shank with an outer diameter less than the diameter of said head within the frame base; and,
eroding an eroded space, the eroded space having an outer diameter exceeding the outer diameter of the shank and extending through the head of the fastener and to the frame coating.

12. The method of claim 11, wherein eroding an eroded space comprises: providing a voltage difference between the erosion electrode and at least one of the fastener and the frame coating.

13. The method of claim 11, wherein eroding an eroded space comprises: advancing the erosion electrode longitudinally along the axis of the fastener.

14. The method of claim 13, wherein eroding an eroded space further comprises:
rotating the erosion electrode as it is advanced longitudinally.

15. The method of claim 11, wherein the eroded space extends through a portion of the frame coating.

16. The method of claim 11, wherein the erosion electrode is a hollow cylinder.

17. The method of claim 11, wherein the erosion electrode is a solid cylinder.

18. The method of claim 11, wherein the erosion electrode is a plurality of pins.

19. The method of claim 11, whereby a flange of the head is separated from a remainder of the fastener.

20. The method of claim 11, wherein the frame base remains intact.

21. The method of claim 13, wherein advancing the erosion electrode longitudinally along the axis of the fastener further comprises:
sensing and recording a contact location when the erosion electrode is in contact with an outer surface of the fastener;
tracking a longitudinal distance traveled relative to the contact position; and,
stopping advancement of the erosion electrode when the longitudinal distance traveled is equal to the distance between the contact position and at least one location within the frame coating.

22. The method of claim 12, the method further comprising adding a dielectric fluid to the electrode, fastener, and coating.

23. The method of claim 12, the method further comprising adding a dielectric fluid to the eroded space.
